(19) United States
(12) Patent Application Publication
(10) Pub. No.: US 2011/0195271 A1
(43) Pub. Date: Aug. 11, 2011

(54) Cast Metal Parts With Cosmetic Surfaces And Methods Of Making Same

(75) Inventors: Stephen ZADESKY, Portola Valley, CA (US); Duco Pasmooij, Los Altos, CA (US)

(73) Assignee: Apple Inc., Cupertino, CA (US)

(21) Appl. No.: 12/813,123

(22) Filed: Jun. 10, 2010

Related U.S. Application Data
(60) Provisional application No. 61/302,842, filed on Feb. 9, 2010.

(51) Int. Cl. B32B 15/01; B22D 25/00; B22D 19/00

(52) U.S. Cl. 428/615; 228/101; 228/176; 228/112.1; 228/110.1; 228/193; 164/98; 164/75

(57) ABSTRACT

A cast metal part has a veneer made of cosmetic metal applied thereto so that the cast metal part has a cosmetic surface. A method for producing a cast metal part with a cosmetic surface comprises applying a veneer of cosmetic metal to a surface of the cast metal part. The cast metal part can be a die cast part, such as die cast aluminum or zinc. The veneer can be thin gauge highly cosmetic aluminum. The veneer of cosmetic metal can be applied to the surface of the cast metal part by placing the veneer into a casting mold used for forming the cast metal part, and casting molten metal onto the veneer in the casting mold. The veneer of cosmetic metal can also be applied to the surface of the cast metal part by solid-state welding, e.g., diffusion bonding, the veneer and the cast metal part together.

### CROSS-REFERENCE TO RELATED APPLICATION

This application claims the benefit of U.S. Provisional Application No. 61/302,842, filed Feb. 9, 2010, the entire disclosure of which is incorporated in its entirety herein by reference thereto.

### BACKGROUND OF THE INVENTION

1. Field of the Invention

The present invention relates to cast metal parts, and more particularly, the present invention relates to applying a cosmetic metal to a cast metal part so that the resulting cast metal part is a monolithic structure having a surface formed of the cosmetic metal.

2. Background Art

Many products in the commercial and consumer industries are metal articles, or contain metal parts. The metal surfaces of these products may be treated by any number of processes to alter the surface to create a desired effect, either functional, cosmetic, or both. One example of such a surface treatment is anodization. Anodizing a metal surface converts a portion of the metal surface into a metal oxide, thereby creating a metal oxide layer. Anodized metal surfaces provide increased corrosion resistance and wear resistance. Such characteristics are important to consumers because they want to purchase products that have surfaces that will stand up to normal wear and tear of everyday use and continue to look brand new. Anodized metal surfaces may also be used in obtaining a cosmetic effect, such as utilizing the porous nature of the metal oxide layer created by anodization for absorbing dyes to impart a color to the anodized metal surface.

Casting metals (e.g., die casting, permanent mold casting, sand casting, and investment casting) is a popular method of manufacturing metal parts or articles. Die cast metals are among the highest volume metal products made in the metalworking industry. Die casting is well suited for low cost manufacture of large quantities of relatively small articles, and can provide near net shape parts that do not require extensive finishing to obtain the shape of the final end product. Die casting involves injecting molten metal into metal molds under high pressure. Die cast metal parts typically weighing up to about 5 kg are common, though larger parts can also be produced by die casting. However, die cast metals, and cast metals made by other casting operations, can have a high porosity due to air entrapment and shrinkage during the casting process. Typically, alloys of aluminum are used as the casting metal, such as aluminum-silicon alloys and aluminum-silicon-copper alloys. The silicon content in casting alloys is typically higher than the amounts in most wrought alloys. Silicon increases the melt fluidity, reducing cracking and improving feeding to minimize shrinkage porosity. The porosity and high content of silicone in cast metals, especially die cast metals, make the surface of cast metals undesirable for cosmetic anodization surface treatments. This is because the porous surface of the cast metal tends to streak due to silicone leaching from the alloy metal.

Accordingly, there is a need for new ways for producing cast metal parts or articles, including cast metal parts or articles with cosmetic surfaces to provide the cast articles with an aesthetic appearance. The present application satisfies these and other needs, and provides further related advantages, as will be made apparent by the description of the embodiments that follow.

### BRIEF SUMMARY OF THE DISCLOSURE

A cast metal part or article can have another metal applied the surface of the cast metal. The metal applied to the surface of the cast metal can be a cosmetic metal veneer with different properties from the cast metal whereby the cast metal part is imparted with the properties of the cosmetic metal. Surface treatments such as anodization can be successfully applied to the metal veneer to achieve a desired aesthetic appearance that may not be obtained if the same surface treatment were applied to a cast metal surface. The metal veneer can also provide the cast metal part with a surface that can have improved or desired functional properties that may be lacking in the underlying cast metal. For example, anodized metal surfaces can provide increased corrosion resistance and wear resistance, and can also provide a porous substrate conducive to absorbing dyes to impart a color to the anodized metal surface.

Cast metal parts or articles can also be made to have other substances embedded therein, such as electronics and reinforcement materials including carbon fiber in the form of fillers, wovens or nonwovens, for example.

Applications of such cast metal parts or articles can include electronic components and enclosures, household appliances and cookware, automotive or motor parts, conveyer parts, aircraft and marine hardware, and athletic equipment, for example.

In broad terms, a cast metal part with a cosmetic surface can be created by applying a veneer made of a cosmetic metal to the surface of the underlying cast metal. In one embodiment of a method according to the present invention, the veneer of cosmetic metal can be applied to the surface of the cast metal part during casting of the metal part. The veneer can be placed into a casting mold used for forming the cast metal part, and molten metal can be cast onto the veneer in the casting mold. In another embodiment of a method according to the present invention, the veneer of cosmetic metal can be welded to the surface of the cast metal part, such as by solid-state welding (e.g., diffusion bonding) the veneer and the cast metal part together.

### BRIEF DESCRIPTION OF THE DRAWINGS/FIGURES

The accompanying drawings, which are incorporated herein and form a part of the specification, illustrate the present invention by way of example, and not by way of limitation. The drawings together with the description, further serve to explain the principles of the invention and to enable a person skilled in the pertinent art to make and use the invention.

FIG. 1 is a flowchart of an exemplary method for producing a cast metal part with a cosmetic surface, in accordance with one embodiment of the present application.

FIG. 2 is a flowchart of an exemplary method for producing a cast metal part with a cosmetic surface, in accordance with one embodiment of the present application.

FIG. 3 is a cross-sectional side view of an exemplary casting mold useful for practicing a method in accordance with an embodiment of the present application.

FIG. 4 is a cross-sectional side view of an exemplary casting mold useful for practicing a method in accordance with an embodiment of the present application.

FIG. 5 is a cross-sectional side view of an exemplary cast metal part that can be made according to an embodiment of a method of the present application.

FIG. 6 is a flowchart of an exemplary method for producing a cast metal part with a cosmetic surface, in accordance with one embodiment of the present application.

FIG. 7 is a perspective view of a cast metal part and a metal veneer prior to being bonded together, in accordance with an embodiment of a method of the present application.

FIG. 8-11 are cross-sectional side views of the cast metal part and the veneer of FIG. 7 at different stages in a process for producing a cast metal part with a cosmetic surface, in accordance with an embodiment of a method of the present application.

FIG. 12 is a perspective view of an exemplary electronic device including a cast metal part that can be made according to an embodiment of a method of the present application.

FIG. 13 is a perspective view of an exemplary electronic device including a cast metal part that can be made according to an embodiment of a method of the present application.

### DETAILED DESCRIPTION OF THE INVENTION

The present application will be described with reference to the accompanying drawings, in which like reference numerals refer to similar elements. While specific configurations and arrangements are discussed, it should be understood that this is done for illustrative purposes only. A person skilled in the pertinent art will recognize that other configurations and arrangements can be used without departing from the spirit and scope of the present invention. It will be apparent to a person skilled in the pertinent art that this invention can also be employed in a variety of other applications. Moreover, for brevity, “metal part” is used throughout the present application interchangeably with “metal article”, and as used herein “metal part” should be considered synonymous with “metal article”, and can refer to stand alone articles and/or metal parts thereof.

A cast metal part can have another metal applied the surface of the cast metal. The metal applied to the surface of the cast metal can be a cosmetic metal veneer to impart the cast metal part with a cosmetic veneer surface and/or the functional properties of the metal veneer. Surface treatments such as anodization can be successfully applied to the metal veneer to achieve a desired aesthetic appearance. Cast metal parts can also be made to have other substances embedded therein, such as electronics and reinforcement materials including carbon fiber in the form of fillers, wovens or nonwovens, for example.

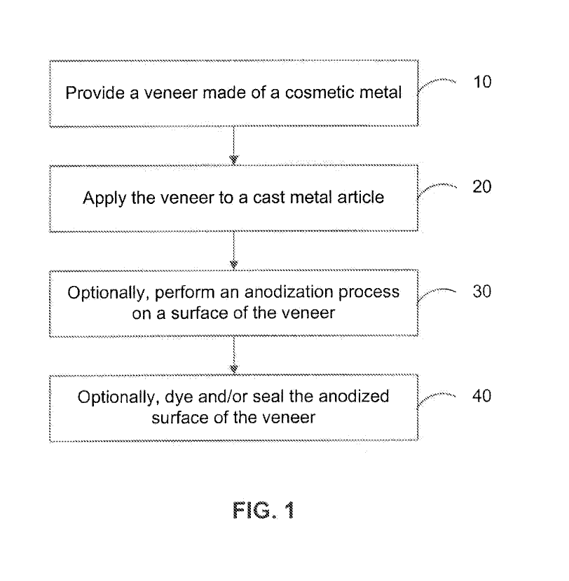

FIG. 1 is a flowchart of an exemplary method for producing a cast metal part or article with a cosmetic surface, in accordance with one embodiment of the present application. The method may include a step 10 of providing a veneer made of a cosmetic metal and a step 20 of applying the veneer to a cast metal part. In some embodiments, when the cosmetic metal of the veneer can be anodized (aluminum, magnesium, zinc, titanium, niobium, and tantalum), the method can further include a step 30 of performing an anodization process on a surface of the veneer, forming an anodized layer, and in some embodiments, step 30 can be followed by a step 40 of dyeing or sealing the anodized surface of the veneer. In step 30, any of one or more anodization processes may be performed on the surface of the veneer as known to one of the skill in the art. Such surface treatments can include, for example, anodization and other post-processing surface treatments as described in co-pending U.S. patent application Ser. Nos. 12/554,596 and 12/692,433, which are incorporated herein in their entireties by reference thereto. In still other embodiments, other surface treatments other than, or in addition to anodization, can be performed, for example, metal plating, lacquering, embossing or polishing, or any other surface treatment known to one skilled in the art that can be used on the particular metal of the veneer. The thickness of the anodized layer can be any achievable thickness, with the thickness typically being on the micron or nanometer level.

The veneer can be made of any metal or alloy thereof, but preferably is made of a highly cosmetic metal, for example, cosmetic aluminum, brass or copper. In some embodiments, the veneer is made from a thin gauge metal sheet. The thickness of the veneer can be selected as needed for the application, and preferably is not be too thin that it warps when applied to the cast metal, or that the anodized layer, if provided, does not penetrate through the veneer to the underlying cast metal. In some embodiments, the thickness of the veneer can range from about 0.1 mm to about 5 mm, from about 0.15 mm to about 0.25 mm in other embodiments, from about 0.15 mm to about 1 mm in other embodiments, and from about 0.5 mm to about 1 mm in other embodiments. In some embodiments, the veneer can be thin gauge highly cosmetic aluminum and can have a thickness in the range of about 0.15 mm to about 2 mm.

The cast metal part can be made of any castable metal and by any of the casting operations known to one of skill in the art. Castable metals are typically non-ferrous casting metal alloys, though ferrous metals may also be used. Exemplary castable metals include zinc, copper (brass), aluminum, magnesium, lead, pewter and tin based alloys. Casting operations for making the cast metal part can include, for example, die casting, permanent mold casting, sand casting, plaster casting, investment casting, continuous casting, lost-foam casting, centrifugal casting, hot isostatic pressing, and combinations thereof or other hybrid processes thereof. The particular casting metal alloy may be chosen based on the casting operation used, the desired end use of the cast metal part, desired tolerances and wall thinness, as well as feasibility, cost and quality factors. In some embodiments, the method of FIG. 1 and the other methods described herein can be used to produce cast metal parts for electronic housing applications, such as housings for MP3 players (see, e.g., FIG. 9), phones and PDAs (see, e.g., FIG. 10), and laptop and desktop computers, for example.

In some embodiments, cast metal parts are made of magnesium, zinc or aluminum alloys as the casting alloy, and in some embodiments, the cast metal parts are die-cast parts. Die casting involves injecting molten metal into metal molds under high pressure, typically in the range of from about 1,450 psi to about 30,500 psi. Popular cast aluminum alloys are aluminum-silicon-copper alloys, among others. For example, AA380 aluminum alloy is a commonly used alloy having about 8.5% silicone and about 3.5% copper. The silicon increases melt fluidity and reduces machinability, and copper increases hardness and reduces the ductility. Compared to the other popular casting methods, particularly sand casting and permanent mold casting, die casting can produce parts with thinner walls, more uniform parts with closer dimensional accuracy (as good as about 0.2% of casting dimension, for example) and smoother surfaces, and die casting can offer low cost, rapid manufacture of near net shape parts, reducing finishing and post-machining costs to bring dimensions to size. A cold chamber or hot chamber die casting operation can be used to make die-cast parts, depending on the casting alloy being used, as known to one of skill in the art. For example, cold chamber casting machines are typically used for alloys of aluminum and other alloys with high melting points, whereas hot chamber machines are used primarily for zinc, copper, magnesium, lead and other low melting point alloys. For example, aluminum alloys can be cast at temperature of about 650° C., and zinc can be cast at a temperature of about 425° C.

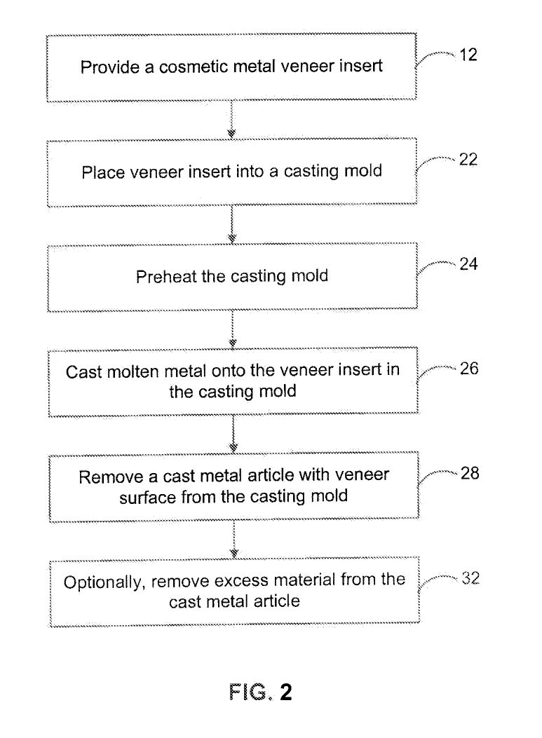

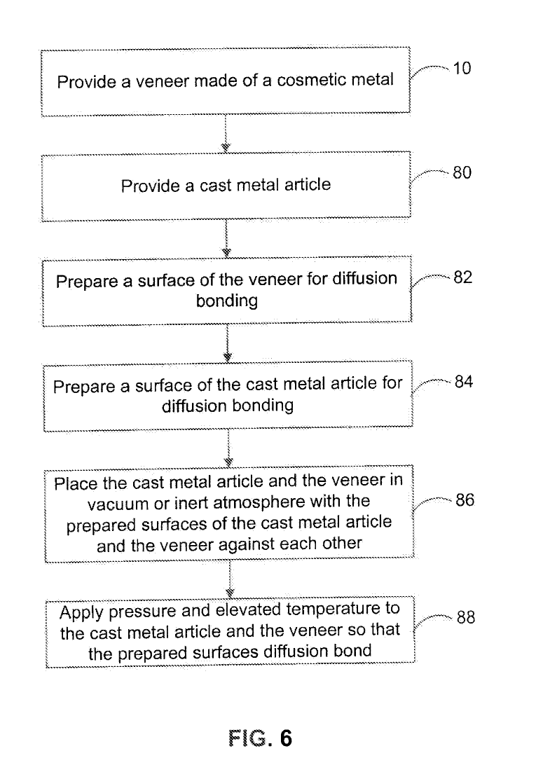

In one embodiment, steps 10 and 20 of the method of FIG. 1 can be performed according to the detailed method of FIG. 2 or later described method of FIG. 6. FIG. 2 is a flowchart of an exemplary method for producing a cast metal part with a cosmetic surface, in accordance with one embodiment of the present application. The method may include a step 12 of providing a cosmetic metal veneer insert, a step 22 of placing the veneer inert into a casting mold so that the veneer lines a surface of the mold, and a subsequent step 26 of casting molten metal onto the veneer insert in the casting mold. The molten metal is cast into the shape of the mold chamber and forms a cast metal part, which can be removed from the casting mold (step 28). The cast metal part has a veneer surface formed by the veneer insert being bonded to the underlying cast metal. If desired, the veneer surface can then be subjected to an anodization process, depending on the metal of the veneer, to form an anodized layer (see step 30, FIG. 1) as well as other post processing steps (see step 40, FIG. 1). In some embodiments according to the present application, the exposed veneer surface may be anodized or subjected to one or more surface treatments before being applied to the cast metal part.

In some embodiments, the removed cast metal part is a near net shape part. To the extent further finishing or dimensioning of the cast metal part is needed or desired, the method can further include a step 32 of removing excess material such as flash from the cast metal part. This step can include, for example, deflashing and/or machining to remove any further excess material or otherwise bring the part's dimensions to size.

In some embodiments, the method can include an intermediate step 24 of preheating the casting mold with the veneer insert prior to casting the molten metal of step 26. This preheating step can provide better adhesion between the veneer insert and the molten metal that is injected into the casting mold in step 26. Without wishing to be bound by any particular theory, it is believed that molten metal can cause localized deformation at the surface of the veneer insert contacted by the molten metal, whereby the casting metal bonds with the veneer insert.

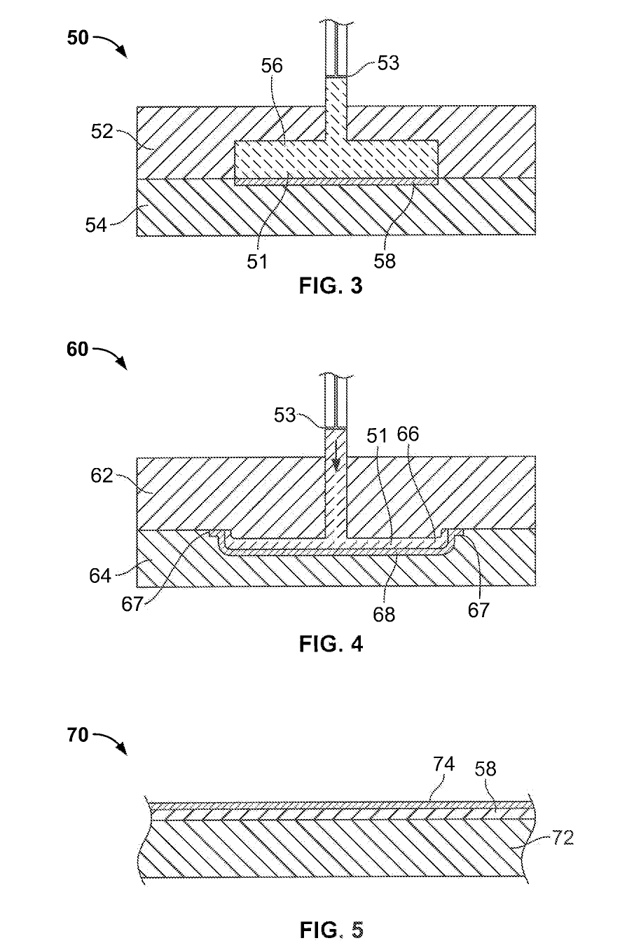

To ensure that the overall integrity of the veneer insert is maintained throughout the casting operation, the metal of the veneer insert can have properties (e.g., thickness and melting point) to withstand the temperatures and pressures of the particular casting operation. For example, preferably, the veneer should not melt, warp, or bond to the mold during the casting operation. Moreover, as further described below with reference to FIGS. 3 and 4, the veneer insert may be a planar insert for providing a veneer to a planar surface of a cast metal part, or may be a 3-D insert that provides continuous coverage to surfaces of cast metal lying on more than one plane. For such 3-D applications, the veneer insert can be deformable into the 3-D shape of the mold. This may be achieved by choosing a sufficiently thin metal veneer that easily forms to the shape of the mold, either alone or when pressure is applied thereto during the casting operation. Alternatively, the veneer insert may be stamp pressed into the mold. The veneer insert may also be configured to include anchor portions or other mounts for securely mounting the veneer insert to the mold surface. In some embodiments, the veneer insert can include other anchor portions, such as protrusions on the surface facing the molten metal, for assisting or enhancing the bond between the veneer insert and the cast metal.

As described above with respect to the embodiment of FIG. 1, the molten metal used in step 26 for casting the cast metal part can be made of any castable metal, and the method can be conducted by any of the casting operations known to one of skill in the art. For example, in one embodiment, the molten metal is an aluminum alloy, and in one embodiment, the veneer is made of a cosmetic aluminum. In one embodiment, the molten metal is a zinc alloy. In some embodiments, die casting is used for casting the molten metal onto the veneer insert, such has illustrated in FIGS. 3 and 4. FIG. 3 is a cross-sectional view of an exemplary die casting mold 50 useful for practicing the method of FIG. 2, in which a planar veneer insert 58 is bonded to a metal part 51 that is cast from a molten metal. As shown in FIG. 3, casting mold 50 is a metal casting mold having a half portion 52 removably mounted to a half portion 54. A mold chamber 56 is formed in casting mold 50. A planar wall of mold chamber 56 is lined with veneer insert 58. Molten metal 51 is injected into mold chamber 56 at high pressure under the force of a plunger 53.

FIG. 4 is a cross-sectional view of an exemplary die casting mold 60 useful for practicing the method of FIG. 2, in which a 3-D veneer insert 68 is bonded to a cast metal part formed from molten metal 51. As shown in FIG. 4, casting mold 60 is a metal casting mold having a half portion 62 removably mounted to a half portion 64. A mold chamber 66 is formed in casting mold 60. A wall of mold chamber 66 that curves into multiple planes is continuously lined with veneer insert 68. Molten metal 51 is injected into mold chamber 56 at high pressure under the force of plunger 53. As shown, veneer insert 68 includes anchor portions 67 that mount into recesses in mold half portion 64, which ensures that veneer insert 68 is properly positioned and secured in mold chamber 66. In some embodiments, anchor portions 67 can be flanges, brackets, clips, hooks, or other mounting mechanism that is attached or is an integral part of the veneer insert. In the embodiment shown in FIG, anchor portions 67 are flanges at a periphery of veneer insert 68 that extend into recesses into mold half portion 64. Anchor portions 67 can also be an integral part of the veneer insert. For example, veneer insert 68 can be made from sheet metal that is cut to include more material than is needed to line the wall of the mold chamber 66, with anchor portions 67 being formed from this extra material of veneer insert 68.

After the necessary cooling and forming time, the cast metal part can be removed from the mold. FIG. 5 illustrates a cross-sectional view of an exemplary cast metal part 70 that can be made according the methods described herein. Cast metal part 70 has a veneer surface formed of veneer insert 58. Cast metal part 70 constitutes a monolithic structure formed of veneer insert 58 and an underlying cast metal 72 that have been fused together along a bond line during the casting operation into a single piece without joints, seams, or discrete layers of material at the bond line. In some embodiments, cast metal 72 can be formed from molten metal 51 using a die casting mold, such as die casting molds 50 or 60 and the method of FIG. 2. If desired, the veneer surface can be subjected to an anodization process, depending on the metal of veneer insert 58; to form an anodized layer 74.

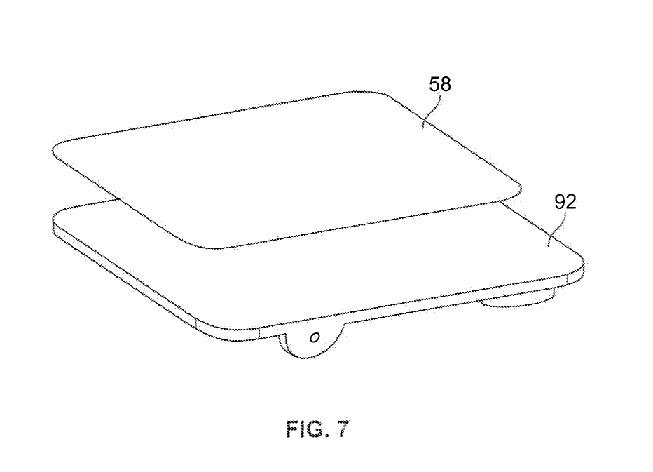

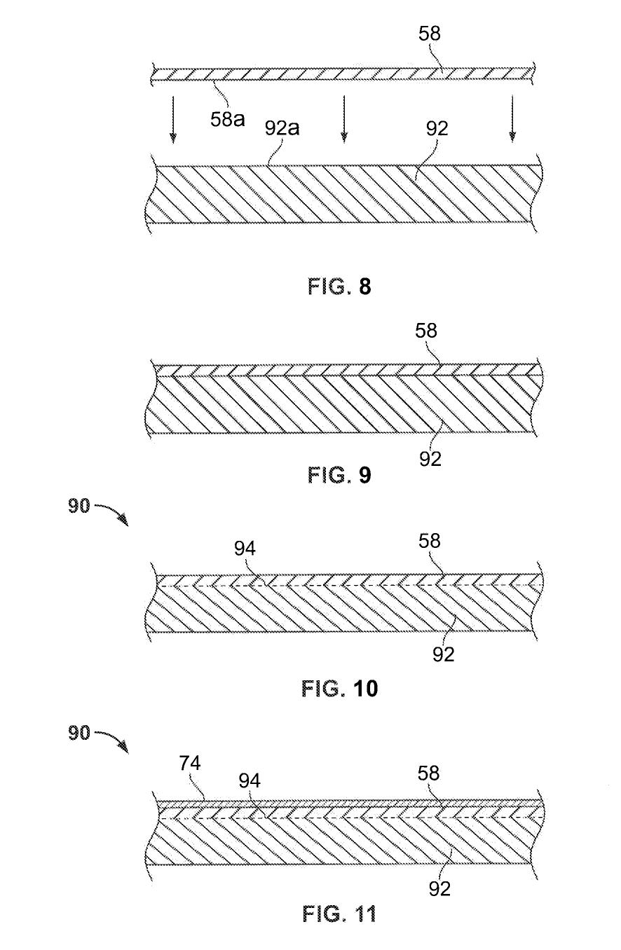

In some embodiments, veneer 58 can be solid-state welded to the underlying cast metal. An exemplary method for producing a cast metal part with a cosmetic surface by diffusion bonding a veneer of cosmetic metal to cast metal will be described with reference to FIGS. 6-11. FIG. 7 is a perspective view of veneer 58 and a cast metal part 92 prior to being diffusion bonded together. FIGS. 8-10 are cross-sectional side views of cast metal part 92 and veneer 58 at different stages in the diffusion bonding process, producing a cast metal part 90 having a cosmetic surface constituted by veneer 58. FIG. 11 is a cross-sectional view of cast metal part 90 with an anodized layer 74 formed on the surface of veneer 58 opposite to the veneer's faying surface bonded to cast metal part 92. A faying surface is a surface of material this is in contact with, or will be in contact with, another surface to which it is or will be joined.

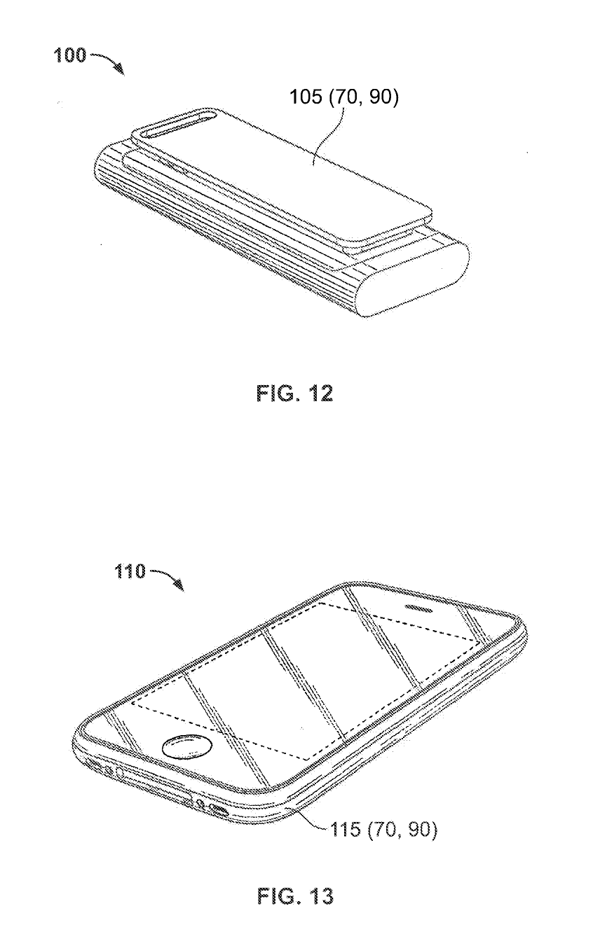

As illustrated in FIG. 6, an exemplary diffusion bonding method may include steps 10, 80, 82, 84, 86, and 88. Step 10 includes providing a veneer of a cosmetic metal (e.g., veneer 58), and step 80 includes providing a cast metal part (e.g. cast metal part 92). Steps 82 and 84 include preparing for diffusion bonding a faying surface of the veneer (e.g., a faying surface 58a, shown in FIG. 8) and a faying surface of the cast metal part (e.g., a faying surface 92a, shown in FIG. 8), respectively. Step 86 includes placing the cast metal part and the veneer in a vacuum or in a protective inert atmosphere (such as dry nitrogen, argon or helium) with the faying surfaces 58a and 92a facing against each other (see FIG. 9). Step 88 includes applying pressure at an elevated temperature to the cast metal part and to the veneer so that the faying surfaces diffusion bond. For example, as shown in FIG. 10, a bond can form at a bond line 94 corresponding to the area where faying surfaces 58a and 92a meet, whereby veneer 58 and underlying cast metal 92 together constitute a single piece without joints, seams, or discrete layers of material at bond line 94. Thus, cast metal part 90 constitutes a monolithic structure formed of veneer 58 diffusion bonded to underlying cast metal 92. In some embodiments, the elevated temperature can be between about 50 to about 90% of the absolute melting point of the metals being diffusion bonded, for example. The pressure helps relieve the void that may occur due to the different surface topographies of the opposing faying surfaces. The applied pressure can range in time, from a few minutes to a few hours, for example. If desired, and depending on the metal of the veneer, the exposed surface of veneer 58 can be subjected to an anodization process to form anodized layer 74, as shown in FIG. 12.

Since diffusion bonding involves the migration of atoms across the faying surfaces, it is important that the opposing faying surfaces are sufficiently close that interdiffusion can result in bond formation. Thus, the faying surfaces are prepared for diffusion bonding so that interdiffusion can result and/or bond strength can be improved. For example, faying surface preparation can include cleaning, flattening and/or polishing the surfaces, and removing or minimizing oxide layers on the faying surfaces, which can affect the ease of diffusion bonding. Filler metal may or may not be used between the faying surfaces, and if used can be in the form of electroplated surfaces. For example, for joining aluminum alloys, insertion of a thin copper or zinc interlayer may be used. For diffusion bonding, a vacuum or an inert atmosphere may not be required, but can be advantageous for reducing detrimental oxidation of the faying surfaces. Diffusion bonding is typically easier for bonding planar surfaces, and can increase in complexity for 3-D bonds.

In some embodiments according to the present application, solid-state welding processes other than diffusion bonding may be used for bonding veneer 58 to cast metal part 92, such as cold welding, friction welding or ultrasonic welding or other solid state welding processes as known to one skilled in the art.

Applications of cast metal parts produced according to the methods described herein can include electronic components and enclosures, household appliances and cookware, automotive or motor parts, conveyer parts, aircraft and marine hardware, and athletic equipment, for example. FIG. 9 illustrates an exemplary MP3 player 100 according to one embodiment the present application. MP3 player 100 has a clip 105 that is formed of a cast metal part (such as cast metal parts 70 and 90) having a planar metal veneer applied to the underlying cast metal of the clip. FIG. 10 illustrates an exemplary electronic device 110 (e.g., phone or PDA) according to another embodiment the present application, in which a device housing 115 is formed of a cast metal part (such as cast metal parts 70 and 90) having a 3-D metal veneer applied to the underlying cast metal of the housing. The planar metal veneer of clip 105 and 3-D metal veneer of housing 115 in FIGS. 9 and 10 can be applied to the underlying cast metal by insert die casting, using the exemplary die cast molds of FIGS. 3 and 4, respectively, or can be applied to the underlying cast metal by any of the other methods described herein.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention.

Therefore, such adaptations and modifications are intended to be within the meaning and range of equivalents of the disclosed embodiments, based on the teaching and guidance presented herein.

For example, using the methods described herein, cast metal parts can also be made to have other substances embedded therein, such as electronic parts and reinforcement materials including carbon fiber in the form of fillers, wovens or nonwovens, for example. Such foreign substances can be imbedded in the cast metal during the casting operation, for example, by placing the substances in the casting mold and then casting the molten metal around the substances. For example, in one embodiment, a surface of the mold chamber can be lined with a carbon fiber net, and the molten metal can then be injected into the mold chamber, whereby the net can become embedded in the cast metal part. Also, in some embodiments, any combinations of the methods herein may be used. For example, a metal veneer may be diffusion bonded on a cast metal part, and the resulting part placed in a mold with a veneer insert therein for casting of molten metal onto the resulting part and the veneer insert. In addition, the methods of the present invention can be used multiples times on the same cast metal part to provide a multiples layers of cast metal and metal veneer (with a layer of veneer then becoming embedded in cast metal). Each layer of metal veneer and cast metal can be the same or different from another layer of metal veneer and cast metal.

In some embodiments, methods according to the present invention can include producing a cast metal part having different metal veneers on different portions of the cast metal part. Further, for example, in some embodiments, a method can including casting a molten metal onto a first veneer in a casting mold and then placing the resulting cast metal part in a mold having a second veneer insert therein, and then casting of additional molten metal onto the resulting cast metal part and the second veneer insert. In some embodiments, methods can include producing a cast metal part having more than one layer of metal veneer on the underlying cast metal. In some embodiments, the cast metal part may be entirely encased in metal veneer, and in other embodiments, only a portion of the cast metal part has a veneer surface.

It is to be understood that the phraseology or terminology herein is for the purpose of description and not of limitation, such that the terminology or phraseology of the present specification is to be interpreted by the skilled artisan in light of the teachings and guidance. In addition, the breadth and scope of the present invention should not be limited by any of the above-described exemplary embodiments, but should be defined only in accordance with the following claims and their equivalents.

What is claimed is:

1. A method, comprising:
providing a veneer made of a cosmetic metal;
providing a cast metal part; and
welding the veneer and the cast metal part together.

2. The method of claim 1, further comprising performing an anodization process on a surface of the veneer to create an anodized layer.

3. The method of claim 2, wherein the anodization process is performed on the surface of the veneer after the veneer is applied to the cast metal part, wherein the anodized layer forms an outer surface of the cast metal part.

4. The method of claim 2, further comprising at least one step of dying the anodized layer and sealing the anodized layer.

5. The method of claim 3, further comprising at least one step of dying the anodized layer and sealing the anodized layer.

6. The method of claim 1, wherein the step of welding comprises solid-state welding the veneer and the cast metal part together.

7. The method of claim 6, wherein the solid-state welding comprises one of cold welding, friction welding, ultrasonic welding, and diffusion bonding the veneer and the cast metal part together.

8. A method for producing a cast metal part, comprising:
providing a cosmetic metal veneer insert;
placing the veneer insert into a casting mold;
casting molten metal onto the veneer insert in the casting mold; and
removing a cast metal part with a veneer surface from the casting mold, wherein the veneer insert forms the veneer surface.

9. The method of claim 8, further comprising preheating the casting mold with the veneer insert placed therein prior to casting molten metal onto the veneer insert.

10. The method of claim 8, wherein the cast metal part removed from the casting mold has excess material including flash material, wherein the method further comprises deflashing the cast metal part.

11. The method of claim 10, further comprising removing any excess material remaining on the cast metal part after deflashing the cast metal part.

12. The method of claim 8, wherein the casting mold is a die casting mold, wherein casting molten metal onto the veneer insert comprising die casting molten metal onto the veneer insert.

13. The method of claim 8, further comprising performing an anodization process on the veneer surface of the cast metal part to create an anodized layer.

14. The method of claim 13, wherein the anodization process is performed on the veneer surface after the veneer insert is applied to the cast metal part, wherein the anodized layer forms an outer surface of the cast metal part.

15. The method of claim 14, further comprising at least one step of dying the anodized layer and sealing the anodized layer.

16. The method of claim 8, wherein the molten metal is an aluminum alloy, and wherein the veneer insert is made of a cosmetic aluminum.

17. The method of claim 8, wherein the veneer insert has anchor portions that secure the veneer insert to the casting mold.

18. A method, comprising:
providing a veneer made of a cosmetic metal;
providing a cast metal part;
preparing a faying surface of the veneer for diffusion bonding;
preparing a faying surface of the cast metal part for diffusion bonding;
placing the cast metal part and the veneer in a vacuum or in an inert atmosphere with the faying surfaces of the cast metal part and the veneer facing against each other; and
applying pressure and an elevated temperature to the faying surfaces of the cast metal part and the veneer so that the faying surfaces diffusion bond.

19. The method of claim 18, further comprising performing an anodization process to create an anodized layer on a surface of the veneer opposite the faying surface of the veneer.

20. The method of claim 19, wherein the anodization process is performed on the surface of the veneer opposite the faying surface after the veneer is applied to the cast metal part.

21. The method of claim 18, wherein the cast metal part is made from an aluminum alloy cast metal, and wherein the veneer is made of cosmetic aluminum.

22. The method of claim 18, providing filler metal between the faying surfaces of the cast metal part and the veneer before the step of applying pressure and an elevated temperature to the faying surfaces.

23. A cast metal part produced according to the method of claim 1.

24. A cast metal part produced according to the method of claim 8.

25. A cast metal part produced according to the method of claim 18.
